(19) United States
(12) Patent Application Publication
(10) Pub. No.: US 2016/0090116 A1
(43) Pub. Date: Mar. 31, 2016

(54) STEERING WHEEL

(71) Applicant: TOYODA GOSEI CO., LTD., Kiyosu-shi (JP)

(72) Inventors: Masako JOH, Kiyosu-shi (JP); Hayato ABO, Kiyosu-shi (JP); Masakazu ASANO, Kiyosu-shi (JP); Mikine HAYASHI, Kiyosu-shi (JP); Kazunari YOKOYAMA, Kiyosu-shi (JP); Naoyuki KUMAGAI, Kiyosu-shi (JP)

(21) Appl. No.: 14/861,015

(22) Filed: Sep. 22, 2015

(30) Foreign Application Priority Data
Sep. 30, 2014 (JP) 2014-199950

(51) Int. Cl. B62D 1/06

(52) U.S. Cl. CPC B62D 1/06

(57) ABSTRACT

A rim of the steering wheel includes a core member, a cladding layer mounted around the core member, a decorative garnish which covers an outer circumference of the rim, and a mounting base on which the decorative garnish is mounted. The decorative garnish includes a decorative region covering the outer circumference of the rim, a positioning projection which protrudes out of the back surface of the decorative region for positioning against the mounting base, and a rib which protrudes out of the back surface of the decorative region in a vicinity of a root region of the positioning projection. The mounting base includes an insert recess for receiving the positioning projection. The cladding layer is disposed in an entire inner circumference of the insert recess and at an abutment seat against which the rib abut when the positioning projection is inserted into the insert recess.

### CROSS REFERENCE TO RELATED APPLICATIONS

The Present application claims priority from Japanese Patent Application No. 2014-199950 of Joh et al., filed on Sep. 30, 2015, the disclosure of which is hereby incorporated into the present application by reference.

### BACKGROUND OF THE INVENTION

1. Field of the Invention

The present invention relates to a steering wheel which is provided with a decorative garnish on an outer circumference of its rim.

2. Description of Related Art

JP 3426999 B discloses a known steering wheel provided with a decorative garnish. The steering wheel includes a core member and a cladding layer which covers an outer circumference of the core member. A mounting base is mounted on an outer circumference of the cladding layer, and the decorative garnish is mounted on the mounting base, thus disposed on an outer circumference of the rim of the steering wheel. In this steering wheel, the mounting base includes a plurality of protrusions which are disposed along a circumferential direction of the rim and protrude towards a decorative region of the decorative garnish. The decorative garnish includes fastening hooks extending towards the mounting base. The decorative garnish is mounted on the mounting base by engagement of the fastening hooks of the decorative garnish and opposite planes of the protrusion which are opposed in a width direction of the decorative region. The mounting base further includes between the protrusions a plurality of projecting tongues projecting towards the decorative region. The projecting tongues are inserted into insert recesses formed on the back surface of the decorative region for positioning of the decorative garnish against the mounting base.

In this conventional steering wheel, the decorative garnish is positioned against the mounting base by inserting the projecting tongues formed on the mounting base into the insert recesses formed on the back surface of the decorative region. Since the decorative garnish and mounting base are in direct contact with each other between the projecting tongues and the insert recesses, there may arise a noise from the steering wheel as mounted on board due to vibration during running.

### SUMMARY OF THE INVENTION

It is an object of the present invention to provide a steering wheel that is capable of suppressing a noise in operation.

The object of the invention will be achieved by a following steering wheel:

The steering wheel has a generally annular rim to be hand held for steering a vehicle, and the rim includes a core member, a cladding layer mounted around the core member, a decorative garnish and a mounting base on which the decorative garnish is mounted. The mounting base is fabricated from a hard synthetic resin having a shape retention property and mounted on the core member. The cladding layer is fabricated from a soft synthetic resin having a cushioning property and covers an outer circumference of the mounting base.

The decorative garnish is fabricated from a hard synthetic resin having a shape retention property and includes:
a decorative region formed into an elongated shape extending generally along a circumferential direction of the rim and exposed on an outer circumference of the rim;
a first fastening element and a second fastening element that are located at opposite end regions in a width direction of the decorative region in a spaced-apart fashion and protrude out of a back surface of the decorative region generally along a rotational center axis of the rim for engagement with the mounting base;
a positioning projection that protrudes out of the back surface of the decorative region generally along the rotational center axis of the rim for positioning against the mounting base; and
a rib that protrudes out of the back surface of the decorative region.

The mounting base includes a fastening recess that is formed generally along the rotational center axis of the rim for receiving and catching the fastening element and an insert recess for receiving the positioning projection.

The cladding layer is disposed in an entire inner circumference of the insert recess and at an abutment seat against which the rib abut when the positioning projection is inserted into the insert recess.

In the steering wheel of the invention, the positioning projection of the decorative garnish protruding towards the mounting base is inserted into the insert recess of the mounting base which are lined with the cladding layer, i.e., with the cladding layer interposed between the positioning projection and the mounting base. The cladding layer is also disposed on the abutment seat against which the rib protruding out of the back surface of the decorative region abut when the positioning projection is inserted into the inset recess. The decorative garnish is mounted on the mounting base by inserting the fastening elements into the fastening recesses in a state where the decorative garnish is positioned against the mounting base with the aid of the positioning projection and the rib. This configuration will adequately prevent the positioning projection and rib from directly contacting the mounting base fabricated from hard synthetic resin as mounted on board, and therefore satisfactorily prevent a noise which would otherwise arise due to vibration during running.

Therefore, the steering wheel of the invention will prevent or reduce a noise in operation.

In the steering wheel of the invention, since the positioning projection protrudes out of the back surface of the decorative region generally along the rotational center axis of the rim, an inserting direction of the positioning projection into the insert recess coincides with an inserting direction of the fastening elements into the fastening recesses, such that the positioning projection can be inserted into the insert recess at the same time as the fastening elements are inserted into the fastening recesses. Mounting errors in a direction orthogonal to an axial direction of the positioning projection, in other words, mounting errors in a direction extending along the rim plane of the rim will be absorbed since the positioning projection is inserted into the insert recess lined with the cladding layer. Moreover, the rib abuts against the abutment seat formed on the mounting base as the positioning projection is inserted into the insert recess. The abutment seat serves as a stopper at inserting work of the fastening elements into the fastening recess and inserting work of the positioning projection into the insert recess, and the rib abuts against the abutment seat in such a manner as to be kept from direct contact with the mounting base because of the cladding layer interposed between the rib and abutment seat. Therefore, mounting errors in a direction parallel to the rotational center axis of the rim will also be absorbed when the positioning projection is inserted into the insert recess. As a consequence, with the steering wheel of the invention, the decorative garnish will be firmly assembled with the mounting base with as less mounting errors as possible between the mounting base and decorative garnish.

In the steering wheel of the invention, it is desired that:
the first fastening element includes a shank region protruding out of the back surface of the decorative region and a hook region protruding generally orthogonally to the shank region at a leading end of the shank region, the shank region being elastically deformable; and
the second fastening element includes a flat plane that is slidable on an inner circumferential plane of the fastening recess.

With this configuration, since the shank region of the first fastening element is elastically deformable, the hook region formed at the leading end of the shank region is brought into engagement with a periphery of the fastening recess by bending the shank region. The second fastening element has only to be inserted into the fastening recess since it has a flat plane slidable on the inner circumferential plane of the fastening recess. That is, merely by bending the shank region of the first fastening element, both fastening elements located at opposite end regions in a width direction of the decorative region in a spaced-apart fashion will be brought into engagement with the fastening recesses in an even fashion along the rim plane. As a consequence, the decorative garnish will be mounted on the mounting base firmly, with no complicated assembly work and with as less fear of inadvertent detachment as possible.

Moreover, the steering wheel configured as described above desirably includes on the back surface of the decorative region a plurality of reinforcing elements that are interspatially disposed in a circumferential direction of the rim for preventing the opposite edges in a width direction of the decorative region from spreading out. Such reinforcing elements will prevent the decorative region from bending in such a manner that the opposite edges spread out when mounting the decorative garnish on the mounting base, thus facilitating the fastening work of the fastening elements on the peripheries of the fastening recesses.

### BRIEF DESCRIPTION OF DRAWINGS

FIG. 1 is a plan view of a steering wheel embodying the invention;

FIG. 2 is a sectional view of a rim of the steering wheel of FIG. 1 taken at a position where a fastening hook of a decorative garnish is provided;

FIG. 3 is a sectional view of the rim of the steering wheel of FIG. 1 taken at a position where a fastening tongue of the decorative garnish is provided;

FIG. 4 is a sectional view of the rim of the steering wheel of FIG. 1 taken at a position where a positioning projection of the decorative garnish is provided;

FIG. 5 is a sectional view of the rim of the steering wheel of FIG. 1 taken at a position where a rib of the decorative garnish is provided;

FIG. 6 is a sectional view of the rim of the steering wheel of FIG. 1 taken at a position where a reinforcing rib of the decorative garnish is provided;

FIG. 7 is a sectional view of the rim of the steering wheel of FIG. 1 taken along a circumferential direction of the rim at the position where the positioning projection is provided;

FIG. 8 is a sectional view taken along line VIII-VIII of FIG. 7;

FIG. 9 is a sectional view of the rim of the steering wheel of FIG. 1 taken along a circumferential direction of the rim at the position where the reinforcing rib is provided;

FIG. 10 is a plan view of a front region of the rim as the decorative garnish is removed;

FIG. 11 is a schematic perspective view of the front region of the rim as the decorative garnish is removed;

FIG. 12 is a partial enlarged schematic perspective view of the front region of the rim as the decorative garnish is removed;

FIG. 13 shows sectional end views of the rim as the decorative garnish is removed, (a) of which showing a sectional end view taken along line A-A of FIG. 10, (b) of which showing a sectional end view taken along line B-B of FIG. 10 and (c) of which showing a sectional end view taken along line C-C of FIG. 10;

FIG. 14 shows sectional end views of the rim as the decorative garnish is removed, (a) of which showing a sectional end view taken along line D-D of FIG. 10 and (b) of which showing a sectional end view taken along line E-E of FIG. 10;

FIG. 15 shows a partial enlarged plan view and sectional views of the front region of the rim as the decorative garnish is removed, (a) of which showing the partial enlarged plan view, (b) of which showing a sectional view taken along line F-F of (a) and (c) of which showing a sectional view taken along line G-G of (b);

FIG. 16 is a bottom view of the decorative garnish adapted to be mounted on the steering wheel;

FIG. 17 is a schematic perspective view of the decorative garnish of FIG. 16 as viewed from the back;

FIG. 18 shows sectional end views of the decorative garnish of FIG. 16, (a) of which showing a sectional end view taken along line H-H of FIG. 16, (b) of which showing a sectional end view taken along line J-J of FIG. 16, (c) of which showing a sectional end view taken along line K-K of FIG. 16, (d) of which showing a sectional end view taken along line L-L of FIG. 16 and (e) of which showing a sectional end view taken along line M-M of FIG. 16; and

FIG. 19 shows sectional views illustrating the way a fastening hook of the decorative garnish is caught by a fastening recess of a mounting base at mounting the decorative garnish on the mounting base.

### DESCRIPTION OF PREFERRED EMBODIMENTS

Preferred embodiments of the present invention are described below with reference to the accompanying drawings. However, the invention is not limited to the embodiments disclosed herein. All modifications within the appended claims and equivalents relative thereto are intended to be encompassed in the scope of the claims.

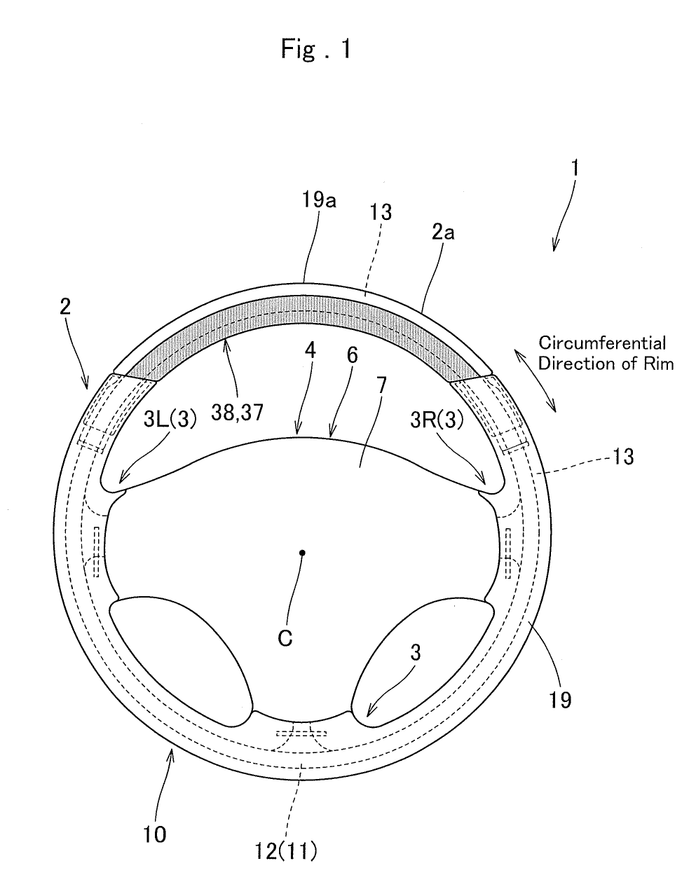

The following embodiments will be described as applied to a leather-covered steering wheel 1, by way of example. As shown in FIG. 1, the steering wheel 1 includes a generally annular rim 2 to be hand held for steering a vehicle, a boss section 4 located at the generally center of the rim 2 and a plurality of (three, in this specific embodiment) spokes 3 which interconnect the rim 2 and the boss section 4. In terms of components, the steering wheel 1 is composed of an airbag device 6 mounted on the boss section 4 and a steering wheel body 10.

Unless otherwise specified, an up/down direction in this specification is intended to refer to a direction extending along a rotational center axis C of the rim 2 (FIG. 1) as the steering wheel 1 is mounted on a vehicle and steered straight ahead, and a horizontal direction is intended to refer to a direction extending along a rim plane of the rim 2 (i.e., a direction extending orthogonal to the rotational center axis C) as the steering wheel 1 is mounted on a vehicle and steered straight ahead.

The airbag device 6 mounted on the boss section 4 includes a not-shown airbag stored in a folded-up configuration, a not-shown inflator for feeding an inflation gas to the airbag, and a pad 7 which covers an upper plane of the airbag. As shown in FIG. 1, the pad 7 covers the boss section 4 and regions of the spokes 3 disposed towards the boss section 4 all over.

As shown in FIG. 1, the steering wheel body 10 includes a core or core member 11, a cladding layer 13, a decorative garnish 37, a mounting base 22, a leather section 19 and a not-shown lower cover. The core 11 has such a contour that the rim 2, boss section 4 and spokes 3 are interconnected. The cladding layer 13 covers the core 11 at the rim 2 and regions of the spokes 3 disposed towards the rim 2. The decorative garnish 37 covers a part of the rim 2 at an outer circumference of the cladding layer 13 and is mounted on the mounting base 22. The leather section 19 covers the rim 2 on the outer circumference of the cladding layer 13 at a region where the decorative garnish 37 is not disposed. The lower cover covers an underside of the boss section 4.

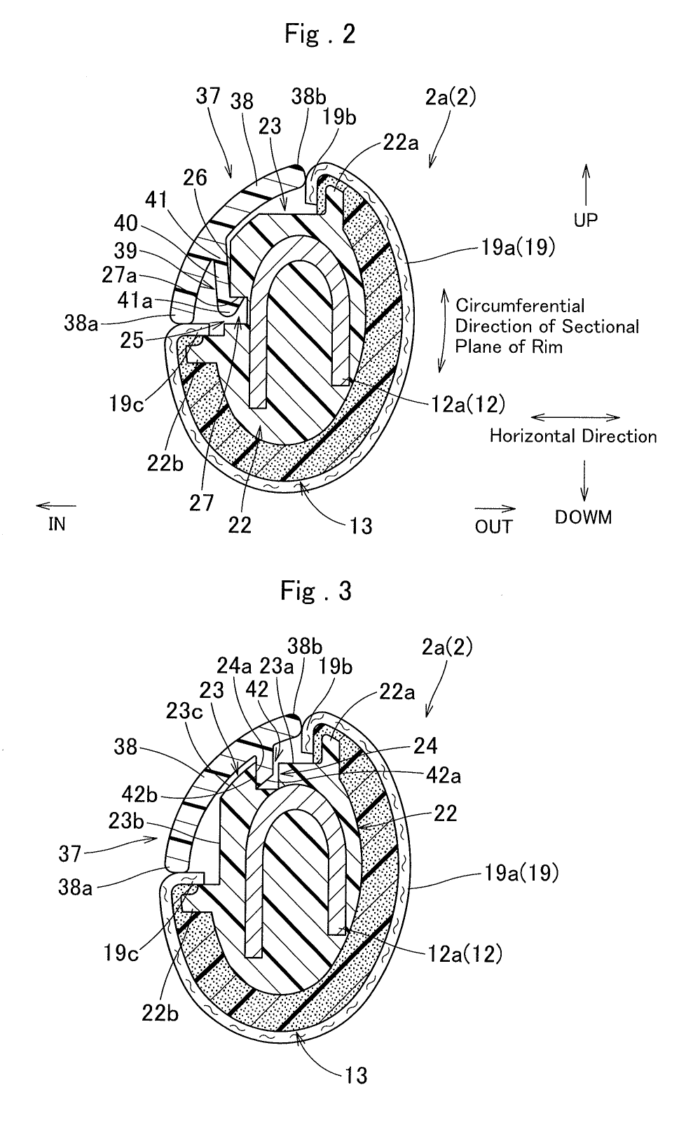

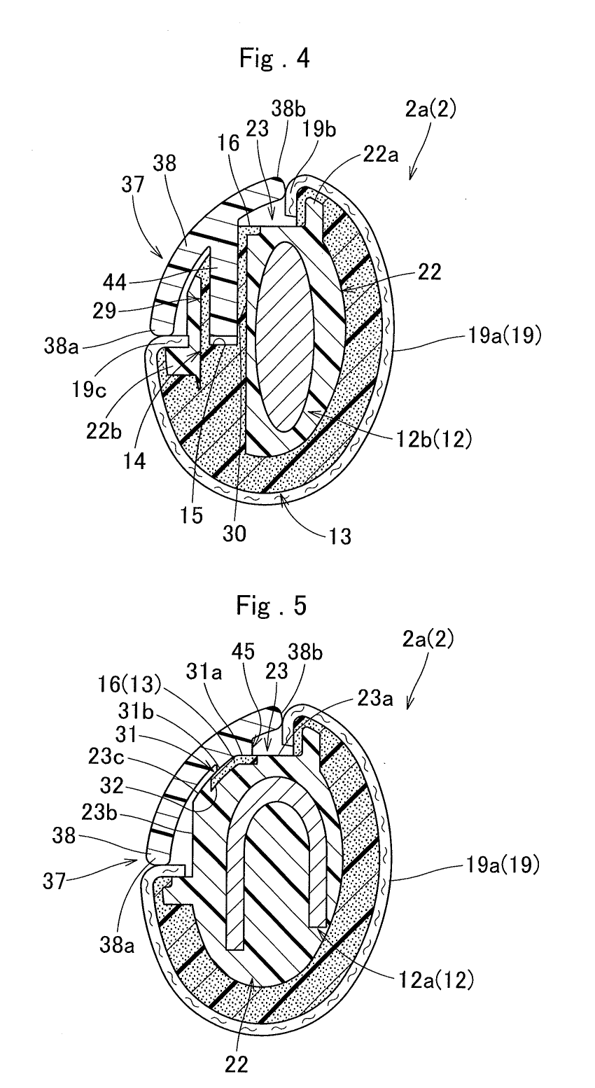

The core 11 is made of such metal as aluminum alloy, and includes a rim core section 12 disposed at the rim 2. The rim core section 12 has a generally inverse U shaped sectional contour. In a front region 2a of the rim 2, which is disposed between the spokes 3L and 3R and where the decorative garnish 37 is mounted, the rim core section 12 has general portions 12a with a generally inverse U shaped sectional contour (FIGS. 2, 3, 5 and 6) and oval portions 12b with an oval sectional contour (FIG. 4) in an alternate fashion. As shown in FIG. 4, each of the oval portions 12b is formed in such a fashion that a region of the general portion 12a disposed at an inner side in a horizontal section (i.e., disposed toward the rotational center axis C) is cut out in order to provide an insert hole 29 (or an opening 30) for receiving a positioning projection 44 formed on the mounting base 22.

The cladding layer 13 is fabricated from a soft synthetic resin having a cushioning property. In this specific embodiment, it is fabricated from soft foamed material such as foamed polyurethane. At the location of the rim 2, the cladding layer 13 has a generally oval sectional contour extending generally vertically, in a generally similar fashion to a sectional contour of the rim 2. In the front region 2a of the rim 2 where the decorative garnish 37 is mounted, the cladding layer 13 is mounted around the mounting base 22 which is attached to the rim core section 12. More specifically, in the steering wheel 1 of this specific embodiment, the decorative garnish 37 is located at an inner upper, one quarter region in an upper half of an inner region in a horizontal direction of a sectional plane of the rim 2 as shown in FIGS. 2 to 6. The cladding layer 13 is so configured as to expose the inner upper region of the mounting base 22 and covers a three-quarter region of an outer circumference of the mounting base 22 except the inner upper region. In particular, as shown in FIGS. 2 to 6, the cladding layer 13 is disposed at a region between and below holding projections 22a and 22b of the mounting base 22, which holding projections 22a and 22b are so formed as to protrude outwardly. That is, the cladding layer 13 is disposed at an outer lower region in the front region 2a of the rim 2.

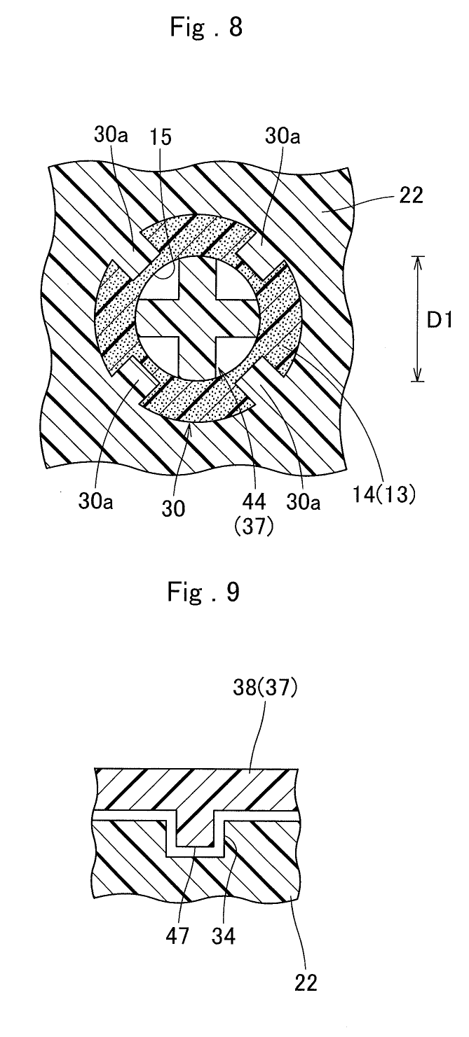

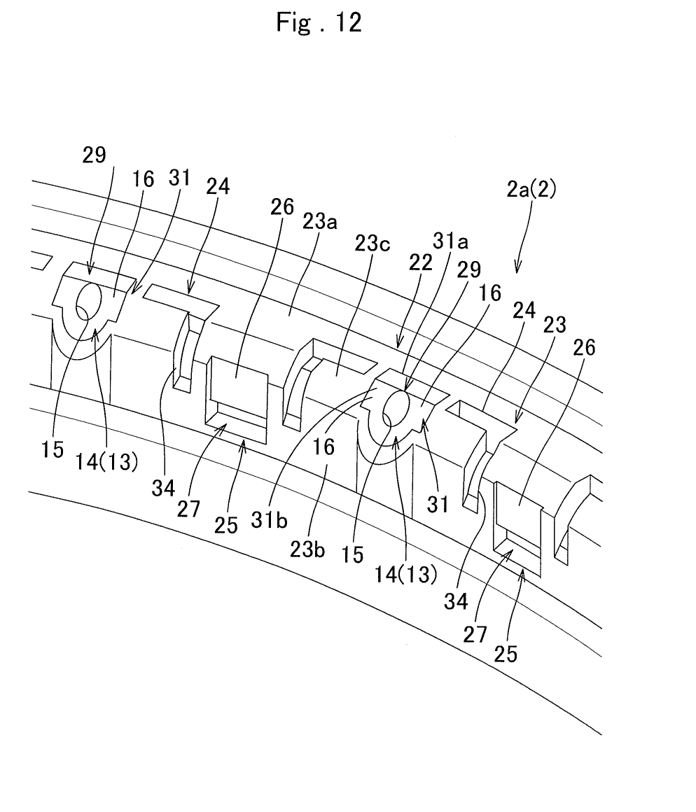

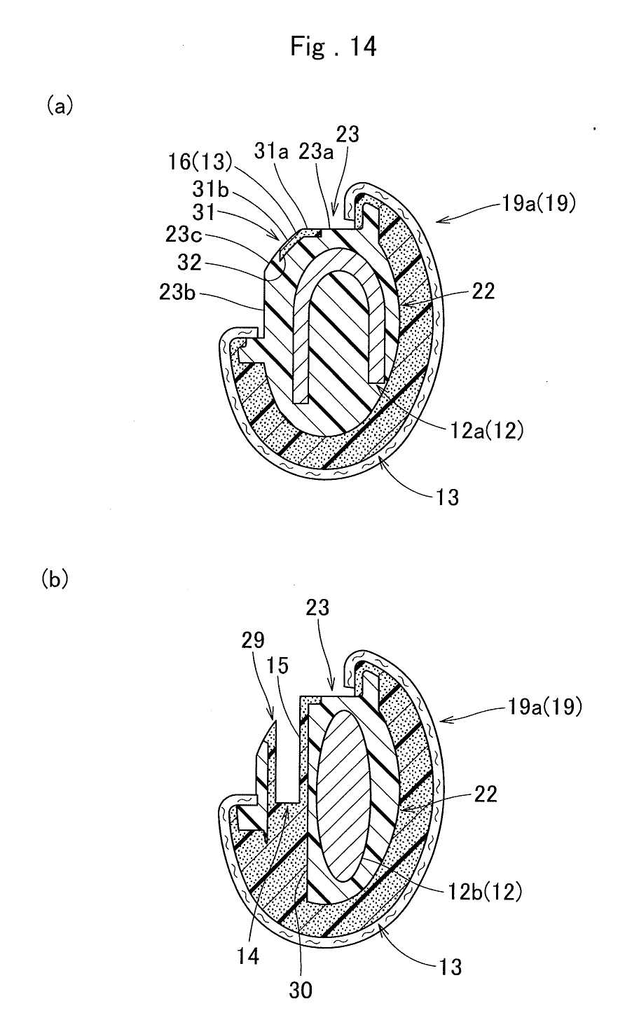

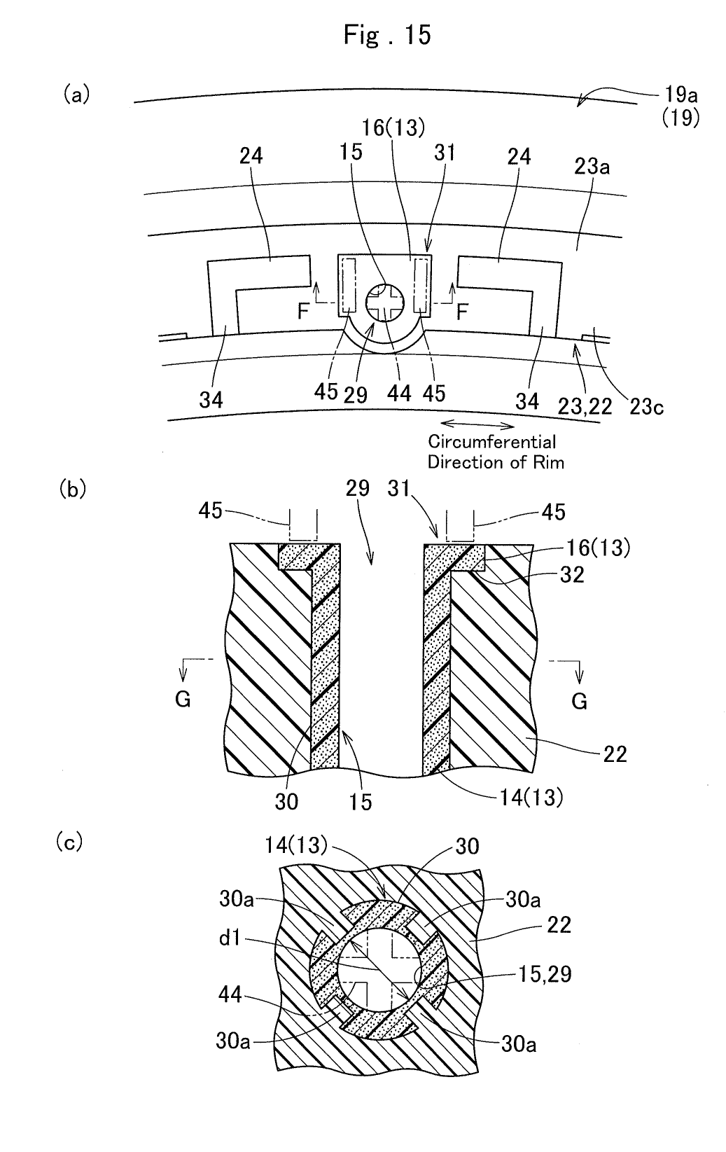

As shown in FIGS. 4, 5, 7 and 8, the cladding layer 13 includes a cover portion 14 that covers an entire inner circumference of a later-described insert hole (insert recess) 29 for receiving the positioning projection 44 and covers a later-described abutment seat 31 against which later-described ribs 45 of the decorative garnish 37 abut in an outer periphery of the insert hole 29. That is, in the illustrated embodiment, the cladding layer 13 is disposed in the entire inner circumference of each of the insert holes 29 and at location of each of the abutment seats 31 on the mounting base 22. More specifically, as shown in FIGS. 12, 14 and 15, the cover portion 14 entirely covers an inner circumference of each of the openings 30 which runs through the mounting base 22 vertically and an upper surface of a later-described sunken region 32 which is formed by denting an outer periphery of an upper end region of each of the openings 30. In the illustrated embodiment, each of the openings 30 runs through the mounting base 22 vertically and has a generally round sectional contour with projections 30a protruding inward from four directions as shown in (c) of FIG. 15. Each of the openings 30 includes in the whole outer periphery at its upper end region a sunken region 32 ((b) of FIG. 15) which is sunken relative to the surrounding. As shown in FIG. 8, the projections 30a of each of the openings 30 are disposed at dislocated positions from later-described protruding regions which are formed at four directions of the positioning projection 44 having a generally cross-shaped sectional contour. As shown in FIGS. 14 and 15, each of the cover portions 14 is so disposed as to fill the opening 30 and the sunken region 32, and includes inside the opening 30 an insert hole body 15 which has a generally round sectional contour and is closed at the leading end (lower end). In the illustrated embodiment, an inner diameter d1 ((c) of FIG. 15) of the insert hole body 15 is the same as an outer diameter D1 (FIG. 8) of the positioning projection 44. A plate-like region 16 of the cover portion 14 so disposed as to fill up the sunken region 32 has such a thickness that the ribs 45 of the decorative garnish 37 may not bottom out when the ribs 45 abut against the plate-like region 16.

The leather section 19 is made of natural leather or synthetic leather, and is wrapped around the cladding layer 13 with the aid of an adhesive. The leather section 19 is divided into more than one parts in a circumferential direction of the rim 2. A front region 19a of the leather section 19 covers the front region 2a of the rim 2. As shown in FIGS. 2 to 6, opposite edges 19b and 19c in a width direction (in a circumferential direction of a sectional plane of the rim 2) of the front region 19a are retained by the holding projections 22a and 22b of the mounting base 22, such that the front region 19a is applied on an outer surface of the cladding layer 13.

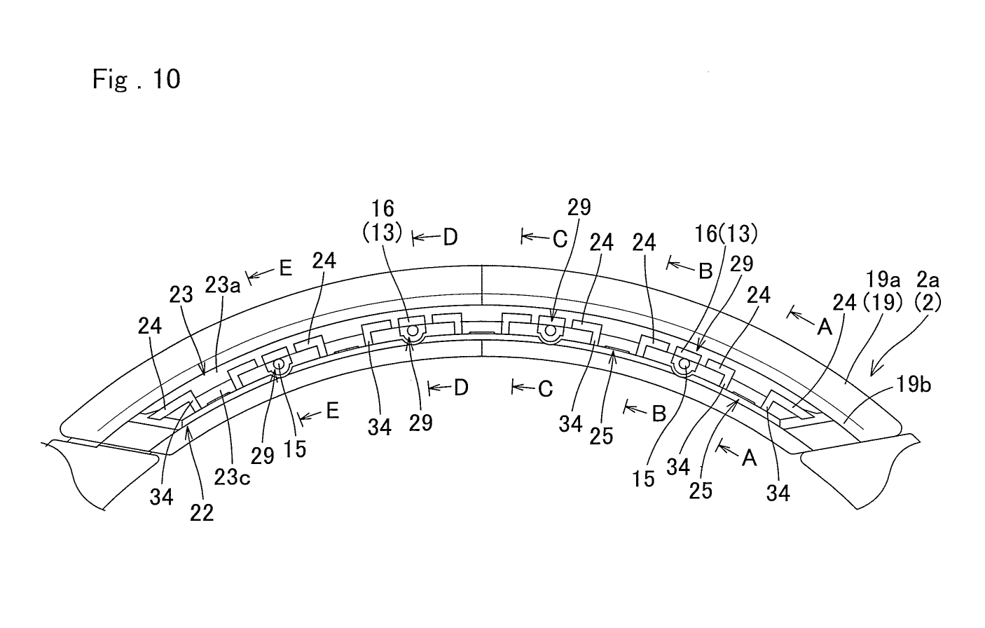

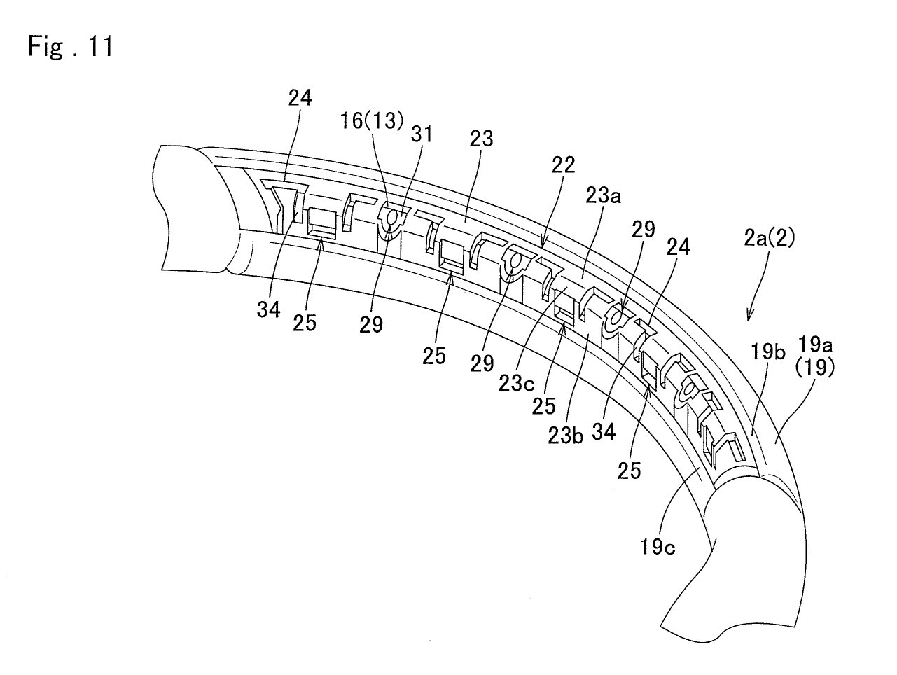

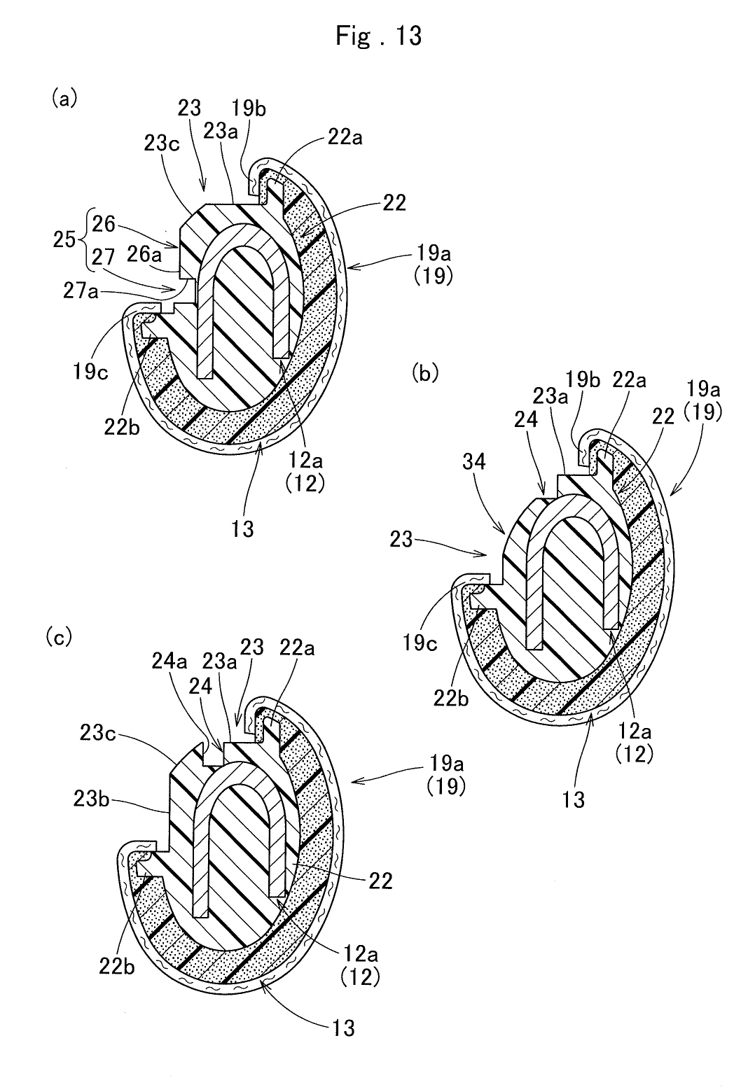

The mounting base 22 is fabricated from hard synthetic resin having a shape retention property. The mounting base 22 of the illustrated embodiment is fabricated of ABS resin. In the illustrated embodiment, the mounting base 22 is mounted on the rim core section 12 by insert molding. The mounting base 22 is disposed only at the front region 2a of the rim 2 where the decorative garnish 37 is mounted. As shown in FIGS. 10 and 11, the mounting base 22 is disposed in a continuous fashion in an entire area where the decorative garnish 37 is mounted, and has a generally oval sectional contour in a generally similar fashion to that of the rim 2 (FIGS. 13 and 14). The mounting base 22 includes two holding projections 22a and 22b that protrude outwardly for retaining the opposite edges 19b and 19c of the front region 19a of the leather section 19. As shown in FIGS. 13 and 14, the holding projection 22a is disposed proximate the upper end of an outer side in a horizontal direction of a sectional plane of the rim 2, and the holding projection 22b is disposed in a vicinity of the center in an up and down direction of an inner side in a horizontal direction of the sectional plane of the rim 2. The holding projections 22a and 22b are so configured that outer surfaces of a later-described decorative region 38 of the decorative garnish 37 and the front region 19a of the leather section 19 are continued smoothly with no gap there between with the opposite edges 19b and 19c retained by the holding projections 22a and 22b as the decorative garnish 37 is mounted on the steering wheel 1, as shown in FIGS. 2 to 6. In this embodiment, a region between the holding projections 22a and 22b (i.e., an inner upper region between the holding projections 22a and 22b) serves as a mounting seat 23 on which the decorative garnish 37 is mounted.

Referring to FIGS. 12 to 14, the mounting seat 23 includes an upper plane 23a which extends generally along the rim plane of the rim 2 (i.e., along a horizontal direction) at an outer side in a horizontal direction, an inner plane 23b which extends generally along the rotational center axis C of the rim 2 (i.e., along an up and down direction) at an inner side in a horizontal direction and a slant plane 23c which is disposed between the upper plane 23a and inner plane 23b and slanted generally along the back surface of the decorative region 38 of the decorative garnish 37. The mounting seat 23 further includes fastening recesses 24 and 25 for catching later-described fastening hooks (as first fastening elements) 39 and fastening tongues (as second fastening elements) 42, respectively, insert holes (or insert recess) 29 for receiving later-described positioning projections 44 of the decorative garnish 37, abutment seats 31 against which later-described ribs 45 of the decorative garnish 37 abut and insert recesses 34 for receiving later-described reinforcing ribs 47 formed on the back surface of the decorative region 38.

Each of the fastening recesses 24 is recessed generally along the rotational center axis C of the rim 2 (i.e., generally along an up and down direction) for retaining the fastening tongue (second fastening element) 42 of the decorative garnish 37. As shown in FIG. 12 and (c) of FIG. 13, the fastening recess 24 of the illustrated embodiment is located inside relative to the center of the sectional plane of the rim 2, and is formed generally into a groove extending generally along a circumferential direction of the rim 2 so as to receive the fastening tongue 42, which has a generally flat plate-like outer contour. Each of the fastening recesses 24 is formed in such a manner that the upper plane 23a is dented downwardly. Each of the fastening recess 24 includes at an inner side in a horizontal direction an inner plane 24a that serves as a guide plane when the decorative garnish 37 is mounted on the mounting base 22. Specifically, when the fastening tongues 42 of the decorative garnish 37 are inserted into the fastening recesses 24 to mount the decorative garnish 37 on the mounting base 22, a later-described flat plane 42b of each of the fastening tongues 42 slides on the inner plane 24a. Once the fastening tongue 42 is completely inserted into the fastening recess 24, the inner plane 24a is in contact with the flat plane 42b of the fastening tongue 42 and retains the fastening tongue 42 (FIG. 3).

Each of the fastening recesses 25 is formed on the inner plane 23b at an inner side in a horizontal direction relative to the fastening recess 24. The fastening recess 25 is formed generally along the rotational center axis C of the rim 2 (i.e., generally along an up and down direction) for catching the fastening hook (first fastening element) 39 of the decorative garnish 37. As shown in FIG. 12 and (a) of FIG. 13, the fastening recess 25 of the illustrated embodiment is formed in such a manner that the inner plane 23b is dented outwardly in a horizontal direction, and includes a guide plane 26 which is sunken relative to the inner plane 23b and a main recess 27 which is located at the lower end 26a of the guide plane 26 and is further sunken relative to the guide plane 26. The guide plane 26 extends generally in parallel with the inner plane 23b, generally along the rotational center axis C of the rim 2 (i.e., generally along an up and down direction), and guides a later-described hook region 41 located at the leading end (or lower end) of the fastening hook 39 towards the main recess 27 when the decorative garnish 37 is moved from top down. The main recess 27 has such an opening width in an up and down direction that allows the hook region 41 to be inserted therein. When the hook region 41 is inserted into the main recess 27, the upper plane 27a of the main recess 27 retains the upper plane 41a of the hook region 41. As shown in FIGS. 10 to 12, the fastening recesses 25 are formed at such positions as to correspond to the fastening hooks 39, and are dislocated from the fastening recesses 24 for catching the fastening tongues 42 in a circumferential direction of the rim 2.

As described above, the mounting base 22 includes openings 30 which run though the mounting base 22 in an up and down direction. Each of the insert holes 29 for receiving the positioning projection 44 of the decorative garnish 37 is formed by forming an insert hole body 15 in the cover portion 14 of the cladding layer 13 which is so disposed as to cover an inner circumferential plane of the opening 30, as described above and shown in (b) of FIG. 14 and FIG. 15. Each of the openings 30 is formed at an inner side in a horizontal direction relative to the center of the mounting base 22. In a circumferential direction of the rim 2, the openings 30 are dislocated from the fastening recesses 24 and 25 (FIGS. 10 to 12). As described above and shown in (a) and (c) of FIG. 15, each of the openings 30 has a generally round sectional contour and is provided with projections 30a which protrude inward from four directions. The cover portion 14 of the cladding layer 13 covers the inner circumferential plane of the opening 30, including those of the projections 30a, all over. At an outer peripheral edge of an upper end region of the insert hole 29, there is provided an abutment seat 31 against which the ribs 45, which are formed in a vicinity of a root region 44b of the positioning projection 44, abut. As shown in (a) of FIG. 15, the mounting seat 31 of the illustrated embodiment is formed at opposite sides of the outer periphery of the insert hole 29 in a circumferential direction of the rim 2, and includes a sunken region 32 sunken in an outer periphery of the opening 30 on the mounting base 22 and a plate-like region 16 of the cover portion 14 so disposed as to fill up the sunken region 32. Thus the surface of the abutment seat 31 is covered by the cladding layer 13 (i.e., by the plate-like region 16), as shown in (a) of FIG. 14 and (b) of FIG. 15. As shown in (a) of FIG. 14, the abutment seat 31 of the illustrated embodiment ranges over the upper plane 23a and slant plane 23c. That is, the abutment seat 31 includes an upper plane 31a extending generally along the rim plane (i.e., in a horizontal direction) on the upper plane 23a and a slant plane 31b disposed on the slant plane 23c.

Referring to FIG. 12 and (b) of FIG. 13, each of the insert recesses 34 is formed in a dented fashion generally along a circumferential direction of a sectional plane of the rim 2 over the inner plane 23b, slant plane 23c and upper plane 23a of the mounting base 22 for receiving a reinforcing rib 47 which is formed generally along a circumferential direction of a sectional plane of the rim 2 (i.e., along a width direction of the decorative region 38). In the illustrated embodiment, each of the insert recesses 34 is formed in such a manner as to continue from the fastening recess 24 for retaining the fastening tongue 42. More specifically, the insert recess 34 continues from an end of the fastening recess 24 farther away from the insert hole 29 (FIGS. 10 to 12). As shown in FIG. 9, the insert recess 34 receives the reinforcing rib 47 in an uncontacting fashion when the decorative garnish 37 is mounted on the mounting base 22.

The decorative garnish 37 is fabricated from hard synthetic resin having a shape retention property. The decorative garnish 37 of the illustrated embodiment is fabricated of a polymer alloy of polycarbonate (PC) and ABS resin (i.e., PC/ABS alloy). As shown in FIG. 1, the decorative garnish 37 has an elongated shape curving along a circumferential direction of the rim 2. As shown in FIGS. 1, 6 and 17, the decorative garnish 37 includes a decorative region 38 formed into an elongated shape extending along a circumferential direction of the rim 2 for covering an outer circumference of the rim 2, fastening hooks (first fastening elements) 39 and fastening tongues 42 (second fastening elements) which protrude out of the back surface of the decorative region 38 and extend generally along the rotational center axis C of the rim 2 (i.e., generally along an up and down direction), positioning projections 44 which protrude out of the back surface of the decorative region 38 and extend generally along the rotational center axis C of the rim 2 (i.e., generally along an up and down direction), ribs 45 which protrude out of the back surface of the decorative region 38 in the vicinity of the root regions 44b of the positioning projections 44 and reinforcing ribs 47 which are formed on the back surface of the decorative region 38 and serve as reinforcing elements.

As shown in FIGS. 2 to 6, the decorative region 38 is so disposed as to cover an inner upper region of the outer circumference of the rim 2 in the front region 2a of the rim 2. More specifically, in the illustrated embodiment, the decorative region 38 is disposed at an inner upper, one quarter region in an upper half of an inner region in a horizontal direction of the sectional plane of the rim 2. That is, the decorative region 38 is disposed in such a slanted fashion that its inner edge 38a is located on the lower side and its outer edge 38b is located on the upper side, while curving, as viewed in a sectional plane of the rim 2.

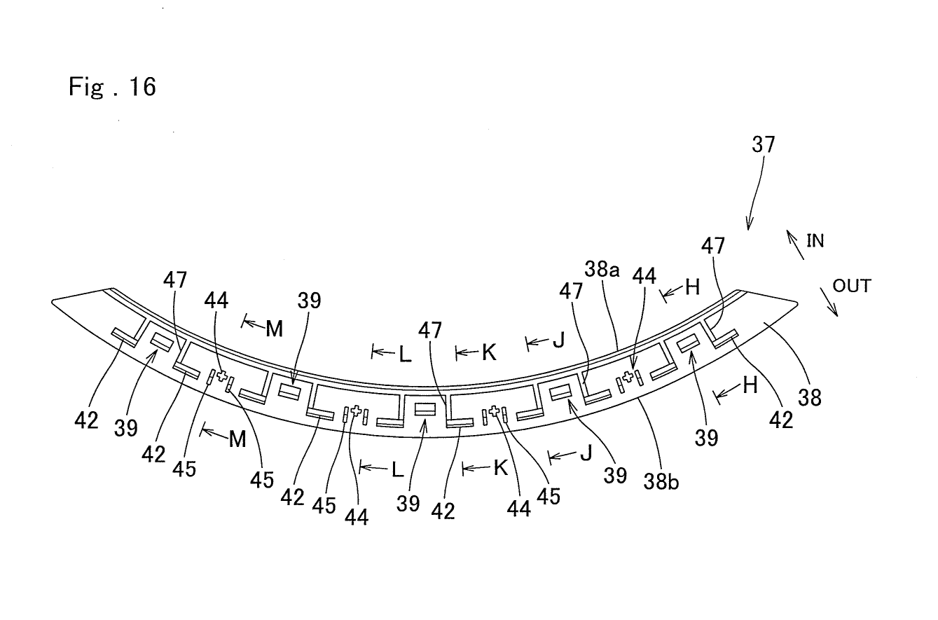

Referring to FIG. 16, the fastening hooks (first fastening elements) 39 and fastening tongues (second fastening elements) 42 are located at opposite end regions in a width direction of the decorative region 38 (i.e., in a horizontal direction) in a spaced-apart fashion for engagement with the mounting base 22. Both of the fastening hooks 39 and fastening tongues 42 protrude downward out of the back surface of the decorative region 38 and extend generally along the rotational center axis C of the rim 2 (i.e., generally along an up and down direction).

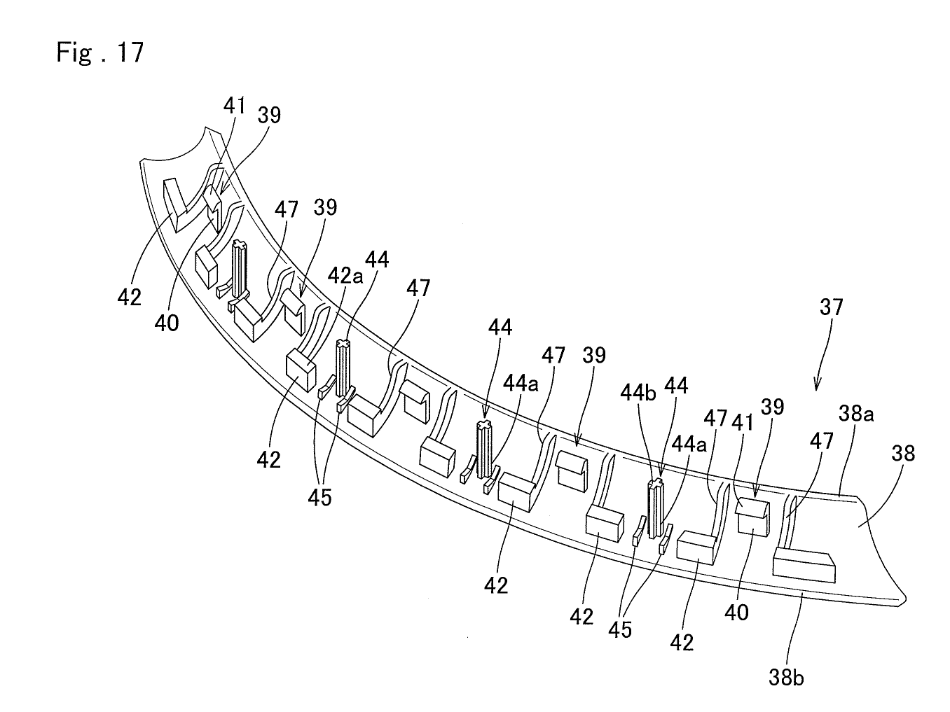

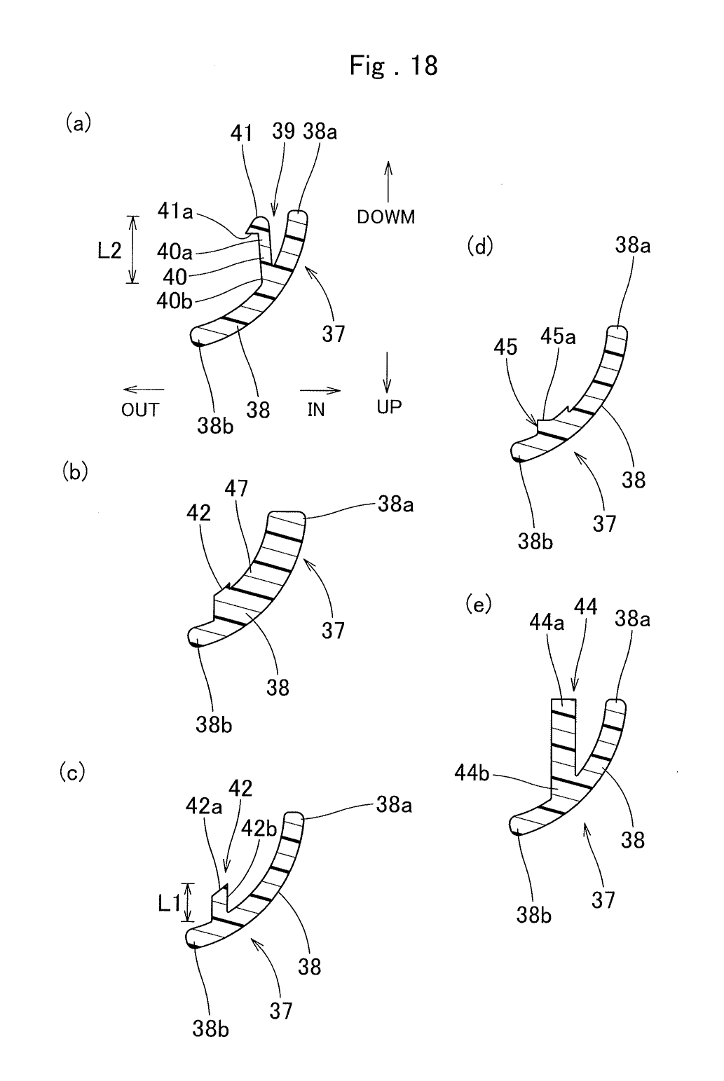

As shown in FIGS. 16 and 17, the fastening hooks 39 are formed in a vicinity of the inner edge 38a of the decorative region 38 in such a manner as to extend along a circumferential direction of the rim 2 (i.e., along a length direction of the decorative region 38). As shown in FIG. 17 and (a) of FIG. 18, each of the fastening hooks 39 includes a shank region 40 which protrudes out of the decorative region 38 in a generally plate-like shape and a hook region 41 which protrudes generally orthogonally to the shank region 40 at the leading end (lower end) 40a of the shank region 40. In the illustrated embodiment, the hook region 41 protrudes outwardly in a horizontal direction. The shank region 40 is elastically deformable (bendable) and is slightly slanted relative to the rotational center axis C of the rim 2 (i.e., an up and down direction) such that its leading end (lower end) 40a is directed farther outwardly in a horizontal direction (in a direction extending along the rim plane) than the root region 40b. That is, the shank region 40 of the fastening hook 39 is slightly slanted relative to the fastening tongue 42 in such a manner as to direct the leading end 40a (or hook region 41) towards the fastening tongue 42. The shank region 40 is also slightly slanted relative to the positioning projection 44. The upper plane (or leading end plane) 41a of the hook region 41 is so configured as to be engageable with the upper plane 27a of the main recess 27 of the fastening recess 25. More specifically, the upper plane (or leading end plane) 41a of the hook region 41 of each of the fastening hooks 39 is so configured as to extend along the rim plane. As shown in FIGS. 16 and 17, a plurality of (five, in the illustrated embodiment) fastening hooks 39 are disposed interspatially in a circumferential direction of the rim 2.

As shown in FIG. 16 and (c) of FIG. 18, the fastening tongues 42 are formed in a vicinity of the outer edge 38b of the decorative region 38 in a spaced-apart fashion from the fastening hooks 39 in a width direction of the decorative region 38 (i.e., in a horizontal direction). Each of the fastening tongues 42 is formed into a generally plate disposed along a circumferential direction of the rim 2 (i.e., along a length direction of the decorative region 38) and protrudes generally along the rotational center axis C of the rim 2 (i.e., along an up and down direction), as shown in FIGS. 16 and 17. An inner plane of each of the fastening tongues 42 serves as a flat plane 42b which slides on the inner plane 24a of the fastening recess 24. As shown in (c) of FIG. 18, the fastening tongue 42 includes at the leading end a slanted plane 42a which is so slanted as to extend the flat plane 42b farther downward relative to the opposite side. The slanted plane 42a helps insert the fastening tongue 42 into the fastening recess 24 smoothly. In the illustrated embodiment, the fastening tongues 42 are dislocated from the fastening hooks 39 in a circumferential direction of the rim 2.

In the illustrated embodiment, the decorative region 38 is so configured that the inner edge 38a is located farther downward than the outer edge 38b, and the fastening tongues 42 located in the vicinity of the outer edge 38b are disposed above the fastening hooks 39 disposed in the vicinity of the inner edge 38a as shown in FIG. 18. In the illustrated embodiment, furthermore, a length (or a protruding amount out of the decorative region 38) L1 (see (c) of FIG. 18) of each of the fastening tongues 42 is about a half of a length (or a protruding amount out of the decorative region 38) L2 (see (a) of FIG. 18) of each of the fastening hooks 39, and the leading end (or lower end) of each of the fastening tongues 42 is located above the root region (the root region 40b of the shank region 40) of each of the fastening hooks 39. That is, in the illustrated embodiment, the fastening tongues 42 and fastening hooks 39 are so disposed as not to overlap as viewed from a horizontal direction (more exactly, as viewed from a horizontal direction extending radially from the rotational center axis C), even if they are disposed face to face in a horizontal (radial) direction. In the illustrated embodiment, moreover, two fastening tongues 42 are located on both sides of one fastening hook 39 in a circumferential direction of the rim 2. That is, as shown in FIGS. 16 and 17, a plurality of (ten, in the illustrated embodiment) fastening tongues 42 are disposed interspatially in a circumferential direction of the rim 2.

As shown in FIG. 16, the positioning projections 44 of the illustrated embodiment are disposed, in location in a horizontal direction, proximate to the fastening hooks 39 and slightly farther to the outer edge 38b than the fastening hooks 39. The positioning projections 44 protrude out of the back surface of the decorative region 38 in the shape of a generally rod. As shown in FIGS. 16 and 17, the positioning projections 44 are dislocated from the fastening hooks 39 and fastening tongues 42 in a circumferential direction of the rim 2. Each of the positioning projections 44 has a generally cross-shaped sectional contour with its four corners dented as shown in FIG. 17. Dented regions of the positioning projection 44 correspond to the projections 30a formed inside the opening 30 of the mounting base 22 as shown in FIG. 8. That is, in the illustrated embodiment, projecting regions formed on the positioning projection 44 and the projections 30a formed in the opening 30 are dislocated in a circumferential direction of the positioning projection 44. As described above, the outer diameter D1 (FIG. 8), i.e., an outer contour, of the positioning projection 44 generally coincides with the inner diameter d1 ((c) of FIG. 15) of the insert hole body 15 of the cover portion 14 (i.e., of the insert hole 29), such that the positioning projections 44 slide on inner circumferential planes of the insert hole bodies 15 in a fitted fashion when being inserted into the insert hole bodies 15. In the illustrated embodiment, moreover, a leading end (lower end) 44a of each of the positioning projections 44 is located on the lower side than the hook region 41 formed at the leading end of the fastening hook 39, as shown in (a) and (e) of FIG. 18. In the illustrated embodiment, as shown in FIGS. 16 and 17, a plurality of (four, in the illustrated embodiment) positioning projections 44 are disposed interspatially in a circumferential direction of the rim 2.

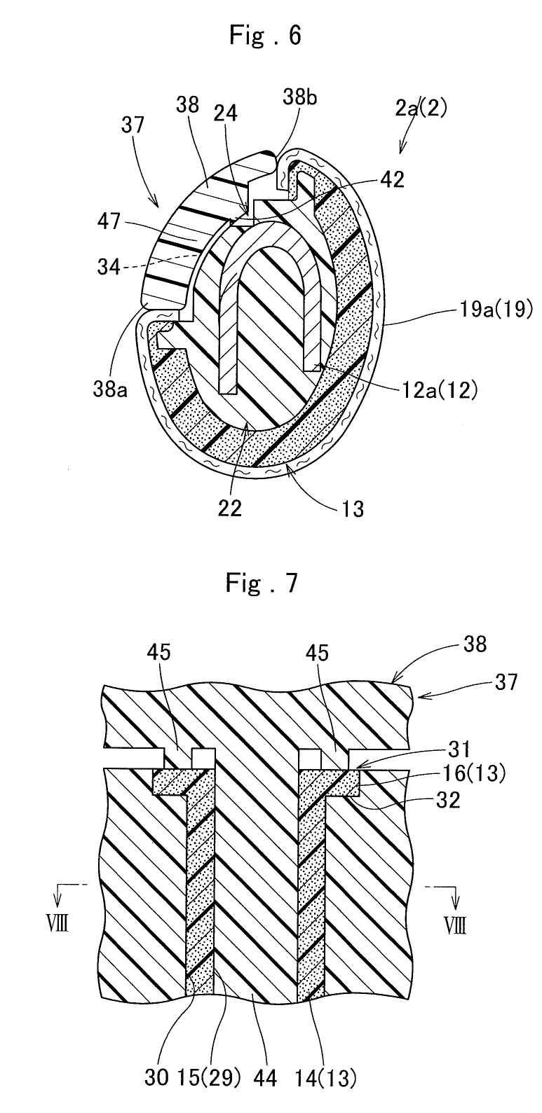

The ribs 45 protrude out of the back surface of the decorative region 38 proximate the root region 44b of each of the positioning projections 44. More specifically, as shown in FIGS. 16 and 17, the ribs 45 are disposed on both sides of each of the positioning projections 44 in a circumferential direction of the rim 2. Each of the ribs 45 is formed into a plate extending generally along a width direction of the decorative region 38 and protrudes downward along the positioning projection 44 for abutment against the abutment seat 31 formed in the periphery of the insert hole 29 when the decorative garnish 37 is mounted on the mounting base 22 (FIGS. 5 and 7). As shown in FIG. 17 and (d) of FIG. 18, the leading end plane 45a of the rib 45 to abut against the abutment seat 31 is bent in such a manner as to correspond to the abutment seat 31 which is disposed over the upper plane 23a and slant plane 23c. As the ribs 45 are disposed on both sides of each of the positioning projections 44, a plurality of (eight, in the illustrated embodiment) ribs 45 are disposed interspatially in a circumferential direction of the rim 2 (FIGS. 16 and 17).

The reinforcing ribs or reinforcing elements 47 are provided for preventing the opposite edges (inner edge 38a and outer edge 38b) in a width direction of the decorative region 38 from spreading out. A plurality of the reinforcing ribs 47 are provided in a circumferential direction of the rim 2. As shown in FIGS. 16 and 17, each of the reinforcing ribs 47 of the illustrated embodiment is formed into a generally plate extending generally along a circumferential direction of a sectional plane of the rim 2 (i.e., along a width direction of the decorative region 38) and protruding downwardly. The reinforcing rib 47 of the illustrated embodiment is continuous with the fastening tongue 42, as shown in FIG. 17 and (b) of FIG. 18. Specifically, each of the reinforcing ribs 47 extends from an end of the fastening tongue 42 farther away from the positioning projection 44 (i.e., from an end of the fastening tongue 42 closer to the fastening hook 39), and continues to the inner edge 38a of the decorative region 38. That is, ten reinforcing ribs 47 are provided interspatially, correspondingly to the fastening tongue 42, in a circumferential direction of the rim 2. The reinforcing ribs 47 are set in the insert recesses 34 of the mounting base 22. As described above, the reinforcing ribs 47 do not contact the insert recesses 34 when the decorative garnish 37 is mounted on the mounting base 22 (FIG. 9).

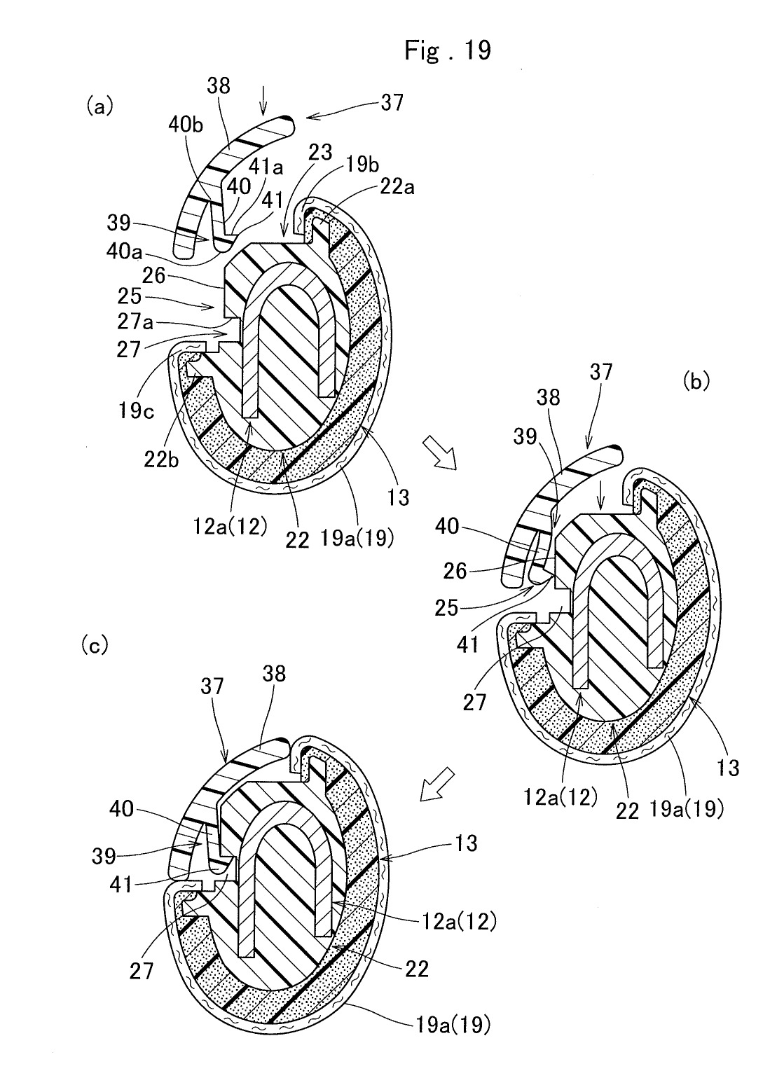

Manufacturing of the steering wheel 1 is now described. Firstly, the mounting base 22 is mounted on the core 11 by means of insert molding. Subsequently, the cladding layer 13 is molded on the rim 2 including an area of the mounting base 22 and regions of the spokes 13 in a vicinity of the rim 2. Thereafter, the leather section 19 is wrapped around the cladding layer 13. Then the decorative garnish 37 is moved downward towards the mounting base 22 such that the positioning projections 44 are inserted into the insert holes 29, the fastening hooks 39 are set in the fastening recesses 25 and the retaining tongues 42 are inserted into the fastening recesses 24. When the hook regions 41 formed at the leading ends of the fastening hooks 39 are set in the main recesses 27 and the upper planes 27a of the main recesses 27 retain the upper planes 41a of the hook regions 41, the decorative garnish 37 is mounted on the mounting base 22. To describe more specifically, in the illustrated embodiment, the leading end 44a of each of the positioning projections 44 is located on the lower side than the hook region 41 formed at the lower end of each of the fastening hooks 39. With this configuration, when the decorative garnish 37 is moved downward towards the mounting base 22 from above the front region 2a of the rim 2 as shown in (a) of FIG. 19, the positioning projections 44 firstly reach the insert holes 29 and are inserted into the insert holes 29. Then guided by the positioning projections 44, the fastening hooks 39 reach the fastening recesses 25 and then the hook regions 41 are moved downward along the guide planes 26 while the shank regions 40 are bent as shown in (b) of FIG. 19. Then if the hook regions 41 reach the main recesses 27 and are set in the main recesses 27, the shank regions 40 restitute and the upper planes 27a of the main recesses 27 retain the upper planes 41a of the hook regions 41 as shown in (c) of FIG. 19. Thereafter, a not-shown lower cover is mounted on the core 11 to complete the steering wheel body 10, and the airbag device 6 is mounted thereon. Thus the steering wheel 1 is manufactured.

In the steering wheel 1 of the foregoing embodiment, the positioning projections 44 of the decorative garnish 37 protruding towards the mounting base 22 are inserted into the insert holes or recesses 29 (insert hole bodies 15) of the mounting base 22 which are lined with the cladding layer 13, i.e., with the cladding layer 13 interposed between the positioning projections 44 and the mounting base 22. The cladding layer 13 is also disposed on the abutment seats 31 against which the ribs 45 protruding out of the back surface of the decorative region 38 abut when the positioning projections 44 are inserted into the inset holes 29. The decorative garnish 37 is mounted on the mounting base 22 by inserting the fastening hooks (i.e., the first fastening elements) 39 and fastening tongues (i.e., the second fastening elements) 42 into the fastening recesses 24 and 25 in a state where the decorative garnish 37 is positioned against the mounting base 22 with the aid of the positioning projections 44 and ribs 45. This configuration will adequately prevent the positioning projections 44 and ribs 45 from directly contacting the mounting base 22 fabricated from hard synthetic resin as mounted on board, and therefore satisfactorily prevent a noise which would otherwise arise due to vibration during running. Although the fastening hooks 39 and fastening tongues 42 of the steering wheel 1 in the foregoing embodiment are in direct contact with the fastening recesses 24 and 25, this will not be a cause of a noise during running because the fastening hooks 39 and fastening tongues 42 are brought into contact with the fastening recesses 24 and 25 with the aid of spring-elastic bending of the shank regions 40 of the fastening hooks 39.

Therefore, the steering wheel 1 of the foregoing embodiment will prevent or reduce a noise in operation.

In the steering wheel 1 of the foregoing embodiment, since the positioning projections 44 protrude out of the back surface of the decorative region 38 generally along the rotational center axis C of the rim 2, an inserting direction of each of the positioning projections 44 into the insert hole 29 coincides with an inserting direction of each of the fastening hooks 39 and fastening tongues 42 into the fastening recess 24/25, such that the positioning projections 44 can be inserted into the insert holes 29 at the same time as the fastening hooks 39 and fastening tongues 42 are inserted into the fastening recess 24/25. Further, mounting errors in a direction orthogonal to an axial direction of each of the positioning projections 44, in other words, mounting errors in a direction extending along the rim plane of the rim 2 (along a horizontal direction) will be absorbed since the positioning projections 44 are inserted into the insert holes 29 lined with the cladding layer 13. Moreover, the ribs 45 abut against the abutment seats 31 formed on the mounting base 22 as the positioning projections 44 are inserted into the insert holes 29. Each of the abutment seats 31 serves as a stopper at inserting work of the fastening hooks 39, fastening tongues 42 and positioning projections 44 into the fastening recesses 24, 25 and insert holes 29, and the ribs 45 abut against the abutment seats 31 in such a manner as to be kept from direct contact with the mounting base 22 because of the cladding layer 13 (plate-like region 16) interposed between the ribs 45 and abutment seats 31. Moreover, each of the abutment seats 31 includes the upper plane 31a formed generally along a horizontal direction and the slant plane 31b slanted relative to the upper plane 31a. That is, in the steering wheel 1 of the foregoing embodiment, the upper plane 31a of each of the abutment seats 31 is disposed in such a manner as to be opposed to the upper plane (leading end plane) 41a of the hook region 41 in each of the fastening hooks 39, and therefore, mounting errors in a direction parallel to the rotational center axis C of the rim 2 (i.e., in an up and down direction) will also be absorbed when the positioning projections 44 are inserted into the insert holes 29, thus a backlash in an up and down direction will be suppressed. As a consequence, with the steering wheel 1 of the foregoing embodiment, the decorative garnish 37 will be firmly assembled with the mounting base 22 with as less mounting errors as possible between the mounting base 22 and decorative garnish 37.

In the steering wheel 1 of the foregoing embodiment, each of the fastening hooks (i.e., the first fastening elements) 39 includes the shank region 40 protruding out of the back surface of the decorative region 38 and the hook region 41 protruding generally orthogonally to the shank region 40 at the leading end of the shank region 40, and the shank region 40 is elastically deformable. Each of the fastening tongues (i.e., the second fastening elements) 42 includes the flat plane 42b which is slidable on an inner circumferential plane (inner plane 24a) of the fastening recess 24. With this configuration, if the hook regions 41 formed at the leading ends 40a of the fastening hooks 39 are brought into engagement with peripheries of the main recesses 27 of the fastening recesses 25 by bending the shank regions 40 of the fastening hooks 39, the fastening tongues 42 have only to be inserted into the fastening recesses 24. That is, merely by bending the shank regions 40 of the fastening hooks (first fastening elements) 39, both fastening elements (the fastening hooks 39 and fastening tongue 42) located at opposite end regions (inner edge 38a and outer edge 38b) in a width direction of the decorative region 38 in a spaced-apart fashion will be brought into engagement with the fastening recesses 24 and 25 in an even fashion along the rim plane (along a horizontal direction). As a consequence, the decorative garnish 37 will be mounted on the mounting base 22 firmly, with no complicated assembly work and with as less fear of inadvertent detachment as possible.

Especially in the foregoing embodiment, the shank region 40 of each of the fastening hooks 39 is slightly slanted relative to the fastening tongue 42 extending in an up and down direction in such a manner as to direct the lower end (leading end 40a) of the shank region 40 outwardly in a horizontal direction, i.e., towards the fastening tongue 42. Each of the fastening hooks 39 is set in the fastening recess 25 by bending the shank region 40 until the hook region 41 formed at the leading end 40a is snapped into the main recess 27. Accordingly, the decorative garnish 37 is mounted on the mounting base 22 in such a manner that the fastening tongues 42 and fastening hooks 39 clamp the mounting base 22 from in and out directions, thus rattling of the steering wheel 1 in a direction along the rim plane (along a horizontal direction) will be adequately prevented. Further, the fastening hooks 39 and retaining tongues 42 are dislocated from each other in a circumferential direction of the rim 2 so as not to overlap each other in an in and out direction. This configuration will facilitate the fastening work to make the fastening hooks 39 and fastening tongues 42 engaged with peripheries of the fastening recesses 24 and 25 by bending the shank regions 40 of the fastening hooks 39 though the fastening hooks 39 are fabricated of hard synthetic resin. Although each of the fastening tongues 42 has a short length in order to facilitate its mounting work, a sufficient fastening force will be secured since two of the fastening tongues 42 are provided per one fastening hook 39, on both sides of the fastening hook 39 in a width direction of the fastening hook 39 (on both sides of the fastening hook 39 in a circumferential direction).

Moreover, the steering wheel 1 of the foregoing embodiment includes on the back surface of the decorative region 38 a plurality of reinforcing ribs (reinforcing elements) 47 that are interspatially disposed in a circumferential direction of the rim 2 for preventing the opposite edges (the inner edge 38a and outer edge 38b) in a width direction of the decorative region 38 from spreading out. The reinforcing ribs 47 will prevent the decorative region 38 from bending in such a manner that the opposite edges (the inner edge 38a and outer edge 38b) spread out when mounting the decorative garnish 37 on the mounting base 22, thus protecting the decorative region 38. The reinforcing ribs 47 will also help bend the shank regions 40 of the fastening hooks 39 smoothly by preventing the decorative region 38 from bending when mounting the decorative garnish 37 on the mounting base 22, thus facilitating the fastening work of the fastening hooks 39 and fastening tongue 42 on the peripheries of the fastening recesses 24 and 25. If such advantageous effects do not have to be considered, the steering wheel 1 may be provided with no such reinforcing ribs 47.

In the steering wheel 1 of the foregoing embodiment, the decorative garnish 37 is located at an inner upper region of the front region 2a of the rim 2. However, the location and shape of the decorative garnish should not be limited thereby. By way of example, the decorative garnish may be formed into such a shape as to cover a half region in a circumferential direction of a sectional contour of the rim, or may be composed of two split parts for covering an entire circumference of a sectional contour of the rim. Further alternatively, the decorative garnish may be so disposed as to extend into the spoke(s).

In the steering wheel 1 of the foregoing embodiment, the decorative garnish 37 includes more than one fastening hooks 39, fastening tongues 42, positioning projections 44 and ribs 45 in a circumferential direction of the rim 2. However, the number of the fastening hooks 39, fastening tongues 42, positioning projections 44 and ribs 45 may be appropriately determined depending on a size of the decorative garnish 37 (depending on a length of the decorative region 38 in a circumferential direction of the rim 2), and the number may be one, respectively for the fastening hook 39, fastening tongue 42, positioning projection 44 and rib 45. Further, although each of the openings 30 formed on the mounting base 22 for forming the insert holes (insert recesses) 29 runs through the mounting base 22, the contour of the insert recess should not be limited thereby. A region for forming the insert recess may be formed by denting the mounting base.

What is claimed is:

1. A steering wheel having a generally annular rim to be hand held for steering a vehicle, the rim comprising:
a core member;
a mounting base that is fabricated from a hard synthetic resin having a shape retention property and mounted on the core member, the mounting base including a fastening recess that is formed generally along a rotational center axis of the rim and an insert recess;
a decorative garnish that is fabricated from a hard synthetic resin having a shape retention property and mounted on the mounting base, the decorative garnish including:
a decorative region formed into an elongated shape extending generally along a circumferential direction of the rim and exposed on an outer circumference of the rim;
a first fastening element and a second fastening element that are located at opposite end regions in a width direction of the decorative region in a spaced-apart fashion and protrude out of a back surface of the decorative region generally along the rotational center axis of the rim, the fastening elements being inserted into and caught by the fastening recesses of the mounting base;
a positioning projection that protrudes out of the back surface of the decorative region generally along the rotational center axis of the rim and is inserted into the insert recess of the mounting base for positioning against the mounting base; and
a rib that protrudes out of the back surface of the decorative region; and
a cladding layer that is fabricated from a soft synthetic resin having a cushioning property and covers an outer circumference of the core member including an outer circumference of the mounting base, the cladding layer being disposed in an entire inner circumference of the insert recess and at an abutment seat against which the rib abut when the positioning projection is inserted into the insert recess.

2. The steering wheel of claim 1, wherein:
the first fastening element includes a shank region protruding out of the back surface of the decorative region and a hook region protruding generally orthogonally to the shank region at a leading end of the shank region, the shank region being elastically deformable; and
the second fastening element includes a flat plane that is slidable on an inner circumferential plane of the fastening recess.

3. The steering wheel of claim 1, wherein a plurality of reinforcing elements are provided interspatially in the circumferential direction of the rim on the back surface of the decorative region for preventing opposite edges in a width direction of the decorative region from spreading out.

4. The steering wheel of claim 2, wherein the shank region of the first fastening element is slightly slanted relative to the second fastening element in such a manner as to direct a leading end of the first fastening element towards the second fastening element.

5. The steering wheel of claim 2, wherein the first fastening element and the second fastening element are disposed at such positions as not to overlap with each other in the circumferential direction of the rim.

6. The steering wheel of claim 2, wherein:
the hook region includes a leading end plane formed generally along a rim plane; and
the abutment seat includes a plane that is disposed to oppose the leading end plane.
